(19) United States
(12) Patent Application Publication
(10) Pub. No.: US 2023/0286858 A1
(43) Pub. Date: Sep. 14, 2023

(54) COMPOSITE MIXTURE AND SYSTEM FOR AQUATIC CONSTRUCTION AND ENVIRONMENTAL PROTECTION AND METHODS OF USE

(71) Applicant: Purdue Research Foundation, West Lafayette, IN (US)

(72) Inventors: Maria Mirian Velay Lizancos, West Lafayette, IN (US); Luciano Castillo, Carmel, IN (US); Oscar M. Curet, Boca Raton, FL (US)

(21) Appl. No.: 18/183,813

(22) Filed: Mar. 14, 2023

Related U.S. Application Data
(60) Provisional application No. 63/319,630, filed on Mar. 14, 2022.

(51) Int. Cl. C04B 7/34; C04B 28/12; C04B 22/06; C04B 7/02; C04B 28/04; B28B 1/00

(52) U.S. Cl. CPC C04B 7/34; C04B 28/12; C04B 22/06; C04B 7/02; C04B 28/04; B28B 1/001; C04B 2111/74

(57) ABSTRACT

Carbon-sequestering composite mixture and methods of carbon sequestration utilizing an aquatic composite structure composed of the composite mixture. The mixture comprises a composite, nanoparticles, and binder. The nanoparticles impact the pore size of the composite mixture, thereby positively impacting the carbon sequestration properties of the mixture. By emplacing an aquatic composite structure composed of such a mixture in an aquatic environment such that it provides erosion mitigation, simultaneous environmental protection effects may be achieved. Further, the binder positively encourages natural ecological growth on the aquatic composite structure, thereby encouraging environmental restoration and encouraging naturally-occurring carbon sequestration from the ecological growth, potentially well past the point at which the aquatic composite structure is unable to continue to sequester carbon.

### CROSS-REFERENCE TO RELATED APPLICATIONS

This application claims the benefit of U.S. Provisional Application No. 63/319,630 filed Mar. 14, 2022, the contents of which are incorporated herein by reference.

### BACKGROUND OF THE INVENTION

The present invention generally relates to materials capable of use in constructions within aquatic environments. The present invention more particularly relates to construction materials suitable for aquatic environments and capable of promoting carbon dioxide sequestration and potentially other forms of environmental protection.

The majority of humanity lives in close proximity to bodies of water, both freshwater and saline. As a result, significant construction in support of human habitation, industry, and commerce occurs in aquatic or semi-aquatic environments. Existing methods and materials of such construction almost always have a direct, negative impact on existing ecological systems and exacerbate existing environmental concerns such as greenhouse gas emission and soil erosion. Due to overarching concerns for wide scale environmental damage done and the potentially catastrophic impact it may have on humanity, environmental restoration and ecosystem preservation are critical concerns faced throughout the world today.

Carbon dioxide (CO₂) sequestration, erosion control and wave mitigation, and habitat restoration are all areas of concerted effort, particularly in aquatic and semi-aquatic environments. Methods of addressing these areas individually are known, however, there are no known methods for addressing each of these areas in a single system. Furthermore, known methods of ecosystem preservation specific to aquatic ecosystems are even less prevalent. However, developing methods specific to aquatic ecosystems is crucial; seventy-one percent of the earth's surface is covered in water, and the preponderance of the human population lives near bodies of water.

CO₂ sequestration refers to the process of storing carbon, for example, atmospheric carbon dioxide, in carbon sinks. Carbon sinks may be anything, natural or manhandle, that accumulate and store carbon-containing chemical compounds for indefinite periods of time, thereby removing carbon CO₂ from the atmosphere. Carbon sequestration naturally occurs via biological, chemical, and physical processes. As is most commonly known, plant life absorbs carbon dioxide from the air as it grows and binds it into biomass. Specifically, ecological growth commonly found in aquatic environments, such as seagrass, mangroves, or salt marsh plant life, naturally sequesters CO₂. However, such naturally-occurring organic CO₂ sequestration processes are limited to geographic locations based on the natural habitat and survivability of the organisms which provide them.

Additionally, certain materials also have the natural ability to sequester CO₂, a notable example being concrete. In the concrete CO₂ sequestration process, calcium hydroxide (possible among other products of concrete hydration) reacts with CO₂ in the atmosphere to form calcium carbonate. However, this process as it occurs with known concrete materials and cementitious composites is inefficient at capturing CO₂ and insufficient to have an appreciable environmental impact. Specifically, current concrete CO₂ sequestration is a prohibitively slow process which often takes several decades to reach the full CO₂ uptake potential of the given material.

Aquatic environments host organic structures, such as seagrass and mangroves, that naturally mitigate against erosion due to wave action thereby helping to at least partly address concerns of erosion and wave mitigation. Furthermore, such ecological growth provides habitats for many other naturally-occurring organisms in a given habitat, thus promoting ecological preservation. Again, however, these living structures are limited to certain geographic areas in which they can survive and thrive based on variables such as temperature and water characteristics.

Man-made efforts to reduce wave erosion include forming structures from durable building materials. The durability of concrete and other cementitious composites makes them an excellent material choice for building aquatic structures. However, known concrete structures employed in aquatic environments further displace the habitats of organisms and have a negative effect on ecological preservation efforts.

In light of the above concerns, a need exists to provide a material, system, and/or method sufficiently durable to be suitable for construction in aquatic environments. Such a material, system, or method would preferably address the aforementioned problems holistically: CO₂ sequestration (with the intended effect of reducing atmospheric greenhouse gasses), erosion control, wave mitigation, habitat preservation, and promotion of naturally-occurring ecological growth.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, compositions, systems, and methods capable of CO₂ sequestration, erosion mitigation, environmental protection, and construction in aquatic environments.

According to one nonlimiting aspect of the invention, a carbon-sequestering aquatic composite mixture comprising a cementitious composite and nanoparticles in a binder and internal pores defining a pore structure within the composite mixture. The nanoparticles interact with the cementitious composite to increase carbon dioxide sequestration properties of the composite mixture, and the binder encourages natural ecological growth on the composite mixture by impacting at least one of the pore structure or pH of the composite mixture.

According to a second nonlimiting aspect of the invention, a method of providing carbon sequestration via an aquatic composite structure. The method includes mixing a cementitious composite, nanoparticles, and a binder to form a composite mixture, shaping the composite mixture into a shape, solidifying the composite mixture to form an aquatic composite structure containing internal pores that defines a pore structure within the composite mixture, and emplacing the aquatic composite structure in a location. The nanoparticles interact with the cementitious composite to increase carbon dioxide sequestration properties of the composite mixture, and the binder encourages natural ecological growth on the composite mixture by impacting at least one of the pore structure or pH of the composite mixture.

Other aspects and advantages will be appreciated from the following drawings and detailed description.

### BRIEF DESCRIPTION OF THE DRAWINGS

FIG. 1 schematic represents a composite structure according to a nonlimiting aspect of the invention.

FIG. 2 is a schematic diagram depicting the composite mixture shaped to form aquatic composite structures that are emplaced to mitigate wave erosion and encourage biological growth in a body of water.

FIG. 3 is a schematic diagram representing an aquatic composite structure of FIG. 2 and illustrating a process by which carbon is sequestered from an ambient environment, saturates pores of the composite mixture, and thereafter sequestered by biological growth.

FIG. 4 is a 3-dimensional (3-D) X-ray image depicting a pore structure of the composite mixture, and depicting a reduction of pore size in various locations representing gaps filled by carbon sequestration.

FIG. 5 represents an approximate volume ratio of a cementitious composite and nanoparticles of the composite mixture.

FIG. 6 is a flowchart depicting a method of forming the composite mixture and an aquatic composite structure therefrom.

### DETAILED DESCRIPTION OF THE INVENTION

The intended purpose of the following detailed description of the invention and the phraseology and terminology employed therein is to describe what is shown in the drawings, which depict and/or relate to one or more nonlimiting embodiments of the invention, and to describe certain but not all aspects of the embodiment(s) depicted in the drawings. The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended provisional claims, and not the detailed description, are intended to recite what at least provisionally are believed to be aspects of the invention, including certain but not necessarily all of the aspects and alternatives described in the detailed description.

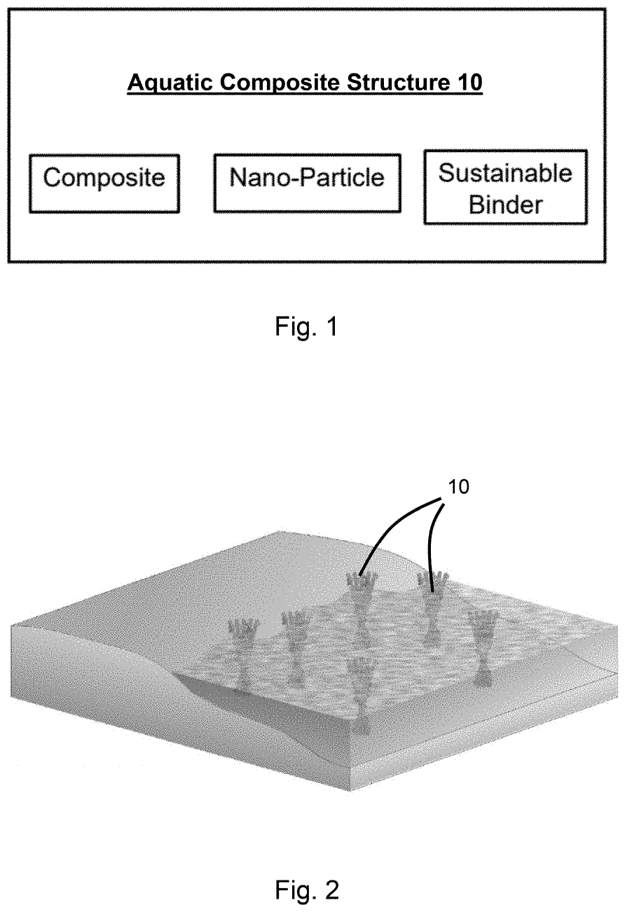

According to one nonlimiting aspect of the invention, a carbon-sequestering composite mixture is provided, the composite mixture comprising a cementitious composite, nanoparticles, and a binder. As indicated in FIG. 1, the cementitious composite can be utilized to form an aquatic composite structure that is preferably sufficiently durable to structurally withstand an aquatic environment, including but not limited to a shoreline subjected to waves, such as in the shoreline environment represented in FIG. 2. The nanoparticles preferably facilitate carbon sequestration from the environment by reducing the pore size of internal pores that define a pore structure within the composite mixture and/or by reducing the size of calcium hydroxide crystals in the composite mixture, thereby improving the CO₂ sequestration properties of the mixture. The binder enhances at least one of the potential hydrogen (pH) or the porosity of the composite mixture, thereby encouraging natural ecological growth on the composite mixture once emplaced.

The cementitious composite may be a concrete paste or some other cementitious composite known to those with skill in the art. Other materials may be present in the composite mixture, as nonlimiting examples, water or other aggregates. In a nonlimiting embodiment, the composite contains or consists entirely of Portland cement.

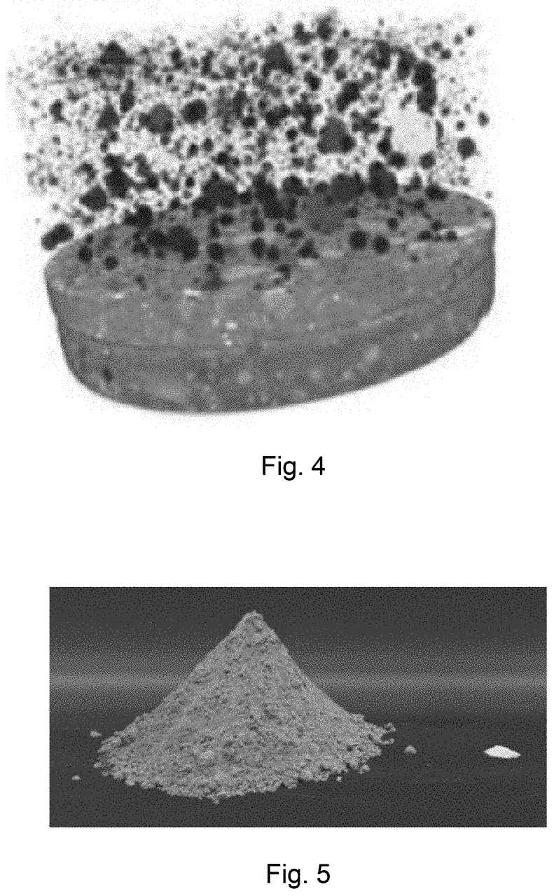

The nanoparticles enhance the rate of CO₂ sequestration by providing and/or altering the internal pores which serve as nucleation sites within the composite mixture. Altering mixture parameters and the ratio of the nanoparticles to the cementitious composite allows the pore structure of the aquatic composite structure to be adjustable. As represented in FIG. 4, the addition of the nanoparticles may be utilized to reduce the size, on a microstructure level, of calcium hydroxide crystals within the composite, thereby increasing the overall surface area of the calcium hydroxide to accelerate CO₂ capture. As a result, the aquatic composite structure doubles the amount of CO₂ captured within a given period of time compared to a comparable structure composed of composite materials that do not contain one or more of the nanoparticles and binder. In a nonlimiting example, the nanoparticles include or consist entirely of titanium dioxide nanoparticles. It is foreseeable that other sources, materials, and/or processes could be utilized to form the composite and/or nanoparticles.

The binder may be tailored to provide various functions in addition to those previously described above. In a nonlimiting example, the binder is an inorganic polymer formed primarily by a reaction between an alkaline solution and an aluminosilicate source. In a particular but nonlimiting embodiment, the binder may be or contain a biomass ash and/or slag cement. The addition of the binder may be utilized to adjust the pH and/or the porosity of the aquatic composite structure in order to encourage the growth of living organisms on the composite mixture or the aquatic composite structure formed thereof.

In another nonlimiting example, the binder adjusts the porosity of the composite mixture to positively impact the infiltration and permeability of the aquatic composite structure, increasing the carbon sequestration capability of the system. In another nonlimiting example, the binder influences the pH and the porosity of the aquatic composite structure to enhance the efficiency of the CO₂ sequestration process deliberately based on the specific aquatic environment's water temperature, salinity, CO₂ concentration, and pressure. It is foreseeable that other sources, materials, and/or methods of providing the binder could be utilized.

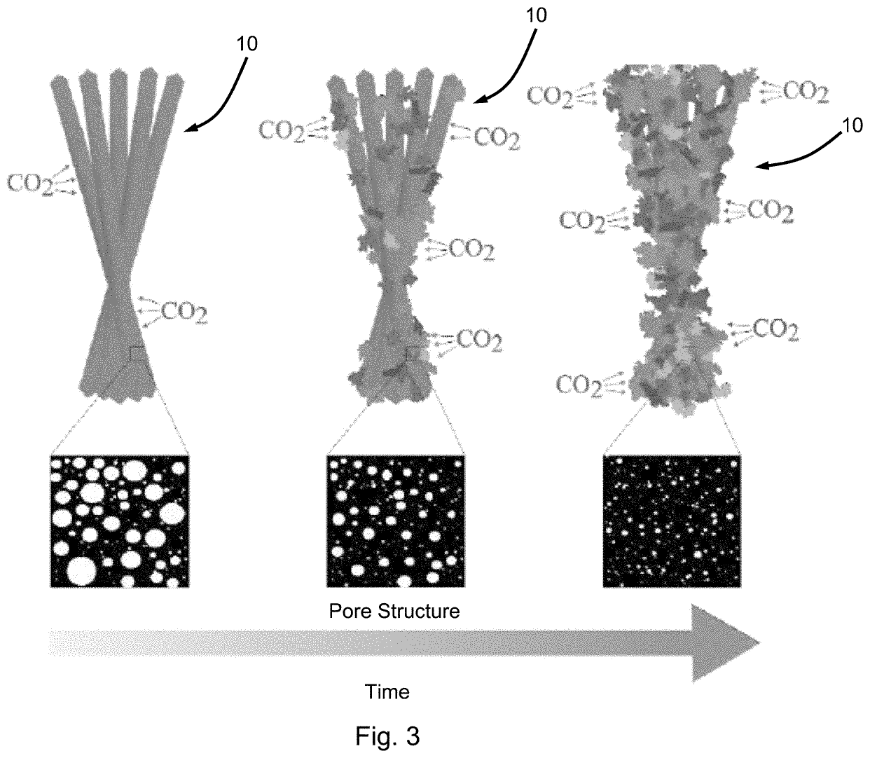

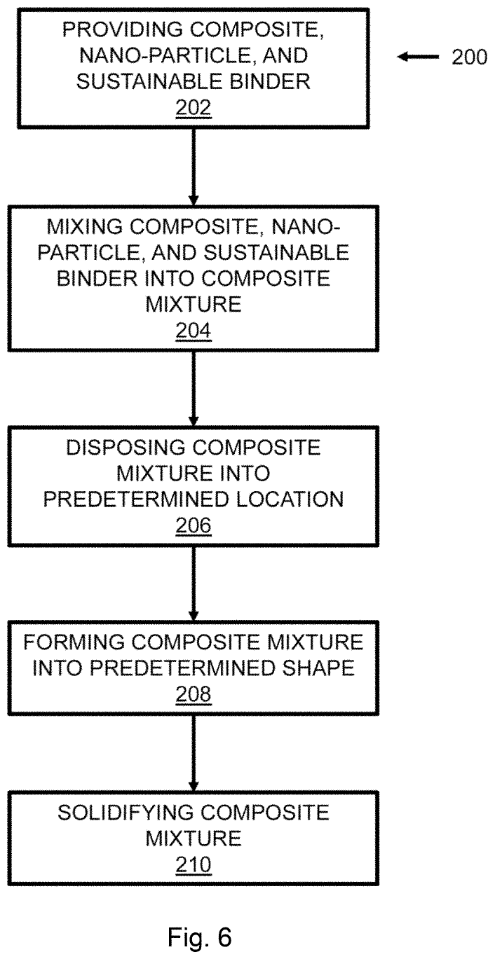

According to another nonlimiting aspect of the invention, a method of providing carbon sequestration via an aquatic composite structure is provided. As represented in FIG. 6, such a method 200 may entail providing a cementitious composite, nanoparticles, and a binder (202), mixing the aforementioned components together to form a composite mixture (204), emplacing the composite mixture into a predetermined location (206), forming the composite mixture into a predetermined shape (208), and allowing the composite mixture to solidify (210), for example, to yield an aquatic composite structure including but not limited to the aquatic composite structures 10 represented in FIGS. 2 and 3. The predetermined shape and location of emplacement of the aquatic composite structure 10 can be chosen to encourage ecological growth thereon as well as mitigate against wave action erosion. In certain embodiments, the shape of the aquatic composite structure 10 imitates existing organism shapes (such as mangroves or seagrass) to encourage ecological growth thereon, reconstitute natural habitats of native organisms, and confer the same or improved erosion mitigation effects as the shapes which they imitate. Further, the shape and location of the aquatic composite structure 10 may provide effects such as flood mitigation or as part of a structure designed to treat acidified water that existing organisms are unable to accomplish.

As described above, the binder can be selected to impact the porosity or pH of the composite mixture and an aquatic composite structure formed thereof in such a way that natural ecological growth thereon is encouraged. The aquatic composite structure is capable of immediately collecting CO₂ and thereafter enables the growth of living organisms onto exposed surfaces of the aquatic composite structure, including organisms that are also capable of sequestering CO₂. The binder is also preferably selected to mitigate against salts within an aquatic environment reacting with calcium hydroxide. Specifically, when the concrete composite is exposed to certain aquatic environments, including seawater environments, chlorides and CO₂ will compete to react with calcium hydroxide of the composite. Preferably, the aquatic composite structure more effectively captures CO₂ where the binder is configured to reduce the pore size and promote a pore distribution of the aquatic composite structure that favors the reaction with CO₂ over chlorides. Further, the crystal size of the calcium hydroxide may also be reduced to mitigate against chlorides reacting with the aquatic composite structure.

The pore structure and chemical composition of the aquatic composite structure may additionally be adapted to encourage and accommodate various living organisms. As a nonlimiting example, the pore structure and chemical composition of the aquatic composite structure may be tailored to increase the probability of seaweed growing on the aquatic composite structure. As schematically represented in FIG. 3, while the aquatic composite structure is configured to initially capture the CO₂ itself, over time seaweeds targeted to grow on surfaces of the aquatic composite structure assume a CO₂ capture role, thereby conferring unique CO₂ sequestration properties far beyond the capabilities of the composite mixture alone.

It should be appreciated that other species with ecological and economic value may be targeted by design to grow on the aquatic composite structure. In some embodiments, the aquatic composite structure is particularly configured to encourage the growth of native species in areas where invasive species are threatening. Likewise, the aquatic composite structure may be employed in areas where conditions optimal for natural ecological growth are not present. For instance, the aquatic composite structure be employed to mitigate coastal erosion in climates colder than where mangrove trees are naturally able to grow. In this example, the aquatic composite structure provides the erosion mitigation naturally provided by mangrove trees while simultaneously encouraging CO₂ sequestration and ecological growth thereon. The aquatic composite structure may also be employed to provide carbon sequestration in fresh water sources where seagrass is unable to thrive. One skilled in the art may select other suitable characteristics to adjust for encouraging ecological growth on the aquatic composite structure, within the scope of the present disclosure.

Various locations, shapes, and methods of emplacing the composite mixture and aquatic composite structure are foreseeable and potentially advantageous. In a nonlimiting example, the composite mixture may be formed into a predetermined shape through additive manufacturing methods, such as 3D printing. The aquatic composite structure may be shaped and solidified before emplacement, or may be emplaced in a preferred location before shaping and solidifying. In certain circumstances, the predetermined location of both solidification and employment is directly in an aquatic environment. In some instances, it may be desirable that the location of manufacture and/or solidification of the aquatic composite structure occurs at an intermediary location, such as an off-site manufacturing facility, before emplacement in an aquatic environment. In a nonlimiting example, the predetermined location includes a pre-cast form and the aquatic composite structure is manufactured and distributed utilizing a pre-cast manufacturing system, in which case the pre-cast aquatic composite system is subsequently transported to an aquatic environment. Due to the diversity of potential environments in which the composite structure may function, the specific needs of the situation may dictate the specific means preferred for shaping and emplacement of the structure.

According to a preferred aspect of the invention, carbon sequestration is capable of occurring with the composite structure well past the point at which the pores of the composite structure are saturated and therefore no longer capable of sequestering carbon by providing a habitat of naturally occurring ecological growth which additionally sequesters environmental carbon. Such growth may not occur without the presence of structure conducive for growth thereon, particularly, as previously described, in environments not directly suitable for such growth, as a result of both natural or manmade causes.

As previously noted above, though the foregoing detailed description describes certain aspects of one or more particular embodiments of the invention, alternatives could be adopted by one skilled in the art. For example, the composite mixture or aquatic composite structure and its components could differ in appearance and construction from the embodiments described herein and shown in the drawings, functions of certain components of the composite mixture or aquatic composite structure could be performed by components of different construction but capable of a similar (though not necessarily equivalent) function, and various materials could be used in the fabrication of the composite mixture, aquatic composite structure, and/or their components. As such, and again as was previously noted, it should be understood that the invention is not necessarily limited to any particular embodiment described herein or illustrated in the drawings.

1. A carbon-sequestering aquatic composite mixture comprising,
a cementitious composite and nanoparticles in a binder; and
internal pores defining a pore structure within the composite mixture;
wherein the nanoparticles interact with the cementitious composite to increase carbon dioxide sequestration properties of the composite mixture, and the binder encourages natural ecological growth on the composite mixture by impacting at least one of the pore structure or pH of the composite mixture.

2. The composite mixture of claim 1, wherein the nanoparticles increase the carbon dioxide sequestration properties of the composite mixture by reducing size of the internal pores of the pore structure.

3. The composite mixture of claim 1, wherein the cementitious composite comprises crystals of calcium hydroxide and the nanoparticles increase the carbon dioxide sequestration properties of the composite mixture by reducing size of the calcium hydroxide crystals.

4. The method of claim 1, wherein the nanoparticles include titanium dioxide nanoparticles.

5. A method of providing a carbon sequestration via an aquatic composite structure, the method comprising:
mixing a cementitious composite, nanoparticles, and a binder to form a composite mixture;
shaping the composite mixture into a shape;
solidifying the composite mixture to form an aquatic composite structure containing internal pores that defines a pore structure within the composite mixture; and
emplacing the aquatic composite structure in a location;
wherein the nanoparticles interact with the cementitious composite to increase carbon dioxide sequestration properties of the composite mixture, and the binder encourages natural ecological growth on the composite mixture by impacting at least one of the pore structure or pH of the composite mixture.

6. The method of claim 5, wherein the nanoparticles increase the carbon dioxide sequestration properties of the aquatic composite structure by reducing size of the internal pores of the pore structure.

7. The method of claim 5, wherein the cementitious composite comprises crystals of calcium hydroxide and the nanoparticles increase the carbon dioxide sequestration properties of the composite mixture by reducing size of the calcium hydroxide crystals.

8. The method of claim 5, wherein the location and the shape of the aquatic composite structure mitigates against erosion.

9. The method of claim 5, wherein the location and the shape of the aquatic composite structure encourages natural biological growth thereon.

10. The method of claim 5, wherein the location and/or the shape of the aquatic composite structure imitates naturally-occurring organic shapes.

11. The method of claim 5, wherein the nanoparticles include titanium dioxide nanoparticles.

12. The method of claim 5, wherein the location is an aquatic environment.

13. The method of claim 5, wherein the composite mixture is shaped and solidified to form the aquatic composite structure before emplacement.

14. The method of claim 5, wherein the composite mixture is shaped using an additive manufacturing method.

15. The method of claim 5, wherein the cementitious composite includes Portland cement.

16. The method of claim 5, wherein encouraged ecological growth provides carbon sequestration after the internal pores of the aquatic composite structure no longer sequester carbon.

17. The method of claim 5, wherein the location is a location naturally unsuitable for naturally-occurring carbon-sequestering ecological growth.

18. The method of claim 5, wherein the shape and the location of the aquatic composite structure mitigates against flooding.

19. The method of claim 5, wherein the aquatic composite structure is emplaced as a component of an acidified water treatment structure.

20. The method of claim 5, wherein the aquatic composite structure encourages the growth of threatened native species thereon.
